(19) United States
(12) Patent Application Publication
(10) Pub. No.: US 2004/0225619 A1
(43) Pub. Date: Nov. 11, 2004

(54) Multivariate negotiation with satisfaction ratings

(76) Inventors: Ernest Marvin Thiessen, Abbotsford (CA); Ian Thomas Upright, Vancouver (CA)

Correspondence Address: William A. Blake, Jones, Tullar & Cooper, P.C., P.O. Box 2266 Eads Station, Arlington, VA, 22202, US

(21) Appl. No.: 10/780,886

(22) Filed: Feb. 19, 2004

Related U.S. Application Data
(60) Provisional application No. 60/448,125, filed on Feb. 20, 2003.

(51) Int. Cl. G06F 17/60

(52) U.S. Cl. 705/80

(57) ABSTRACT

A computer-based system for supporting negotiations with any number of variables and any number of parties. After negotiation variables are created, each negotiating party defines preferred outcomes and associated relative importances for each variable. A neutral site where parties have access only to their own private information and that which other parties share with them manages confidential information. Parties can then create proposals and other packages within those ranges, which may be visible to other parties or not, at their own option. In addition to exchanging conventional proposals in terms of actual values for the negotiation variables, parties may also exchange “reflected” proposals. When a proposal is reflected, what is proposed to another party is merely a rating representing the highest possible potential satisfaction level for that other party, given the reflected proposal, each party's preferences and any constraints imposed on the problem. The proposed rating is generated by the negotiation system and is not revealed to the party submitting the proposal and may also be “blind” to the receiving party. If visible to the other party, the proposed rating may also be associated with a package of actual values for the negotiation variables to assist that party with evaluation. When the rating produced by a reflected proposal is accepted by another party, whether visibly or implicitly in a blind bidding system, then a unique visible package of actual values for the negotiation variables is generated by the negotiation system, which would produce for each party at least as much satisfaction as they have indicated acceptable. Two or more parties reach an agreement when they accept the same visible package.

### CROSS REFERENCE TO RELATED APPLICATIONS

This application claims the benefit, under 35 U.S.C. 119(e), of U.S. Provisional Application No. 60/448,125, filed Feb. 20, 2003.

### BACKGROUND OF THE INVENTION

The present invention relates in general to a computer-based decision support system for multiple parties involved in any type of negotiation. In complex negotiations, the system assists parties in reaching an optimal agreement in terms of the individual and overall joint gains.

Negotiation is a process where two or more parties with conflicting objectives attempt to reach an agreement. This process includes not only bargaining (the presentation and exchange of proposals for addressing particular issues), but also the attempts made by each party to discover and use knowledge of the preferences, strengths and weaknesses of their opponents to reach a resolution that satisfies their own objectives while still being acceptable to other parties. Negotiating parties may be individuals or teams, representing their own interests or the interests of their organizations. When there is at least some willingness to engage in negotiation, it can be a constructive alternative to other means (e.g., stalemate, litigation, violence) of settling disputes.

Negotiators have several basic tasks, which are non-trivial when there are many decision variables (issues) in a negotiation:

| | |
|---|---|
| Qualify Interests: | Identify potential agreements. |
| Quantify Satisfaction: | Determine how party becomes satisfied. |
| Establish Equity: | Agree on how gains should be divided. |
| Maximize Gains: | Find an outcome that maximizes joint gains. |
| Secure Commitment: | Insure that the agreement will be |
| | implemented as intended. |

In order to accomplish these tasks, negotiators must explore the impacts of various decisions, and at least begin to understand the tradeoffs among these impacts. A third party mediator and/or facilitator may be included in a negotiation process to help manage the interactions and offer suggestions for negotiating parties to consider. Alternatively, an arbitrator may be involved with the power to draft and perhaps dictate settlements for the parties. It is commonly recognized that such disinterested parties can significantly help negotiators in their quest for an agreement.

Recent developments in modeling negotiation processes, such as more powerful computers, and the maturing of the Internet, are motivating research in the use of computer-based analysis and network solutions for complex negotiation problems. State-of-the-art interactive interfaces today permit the updating of case descriptions, decision variables, preferences, and interested stakeholders as the negotiation process proceeds.

The current literature on interactive computer programs for multi-objective conflict resolution commonly uses the term “negotiation support system” or simply “negotiation system”. This term refers to the special type of group decision support system designed for providing assistance in situations where there is conflict among various parties as to what decisions to adopt. Research addressing group decision making in multi-objective situations is in its fourth decade, yet the development and use of negotiation systems to facilitate and help guide multi-party negotiations is still considered a relatively new field. Numerous efforts are underway in various kinds of negotiation systems. Existing systems vary from very simple systems for automated single variable blind bidding (usually with money) (e.g., CyberSettle (www.cybersettle.com), ClickNsettle (www.cybersettle.com) to more sophisticated multivariate systems such as Inspire and WebNS (http://interneg.org/interneg/research/papers/2003/02.pdf).

Multivariate systems are generally designed to provide a practical means of increasing the likelihood of mutually agreeable settlements when there exist many possible outcomes on many issues. Sometimes these systems can help identify better solutions than would have been found without their use. The majority of systems described in the literature for complex negotiations, are still in the conceptual stage, or, at best, play a relatively passive role in the negotiation process. The one prior art multivariate negotiation system that stands out in its ability to substantially aid negotiating parties in a complex real-world setting is ICANS, as described in U.S. Pat. No. 5,495,412 and presently implemented in SmartSettle (www.smartsettle.com).

Negotiation systems have one thing in common, in that proposals are made in terms of which decisions to make on the various issues. In the case of systems that only deal with a single issue or variable, a proposal consists of a single number and it is obvious how to propose another number that is better for the other party. Although these single variable systems have a very limited application, they obviously enjoy the advantage of simplicity. Multivariate systems, on the other hand, which are designed to keep preferences of negotiating parties confidential, are much more complex. Since preferences of other parties are generally not known, a negotiator cannot be sure what their party's concession, consisting of a different set of values, will actually mean to the other party. Achieving efficiency and fairness objectives under these conditions is no easy task.

### BRIEF SUMMARY OF THE INVENTION

A computer-based interactive system for supporting multivariate negotiations is disclosed. This system enables decision makers in multivariate negotiations to simply exchange satisfaction ratings, while still meeting the objectives of efficiency and fairness. In effect, this process simplifies the negotiation to exchange of single numbers, just as if the decision makers were negotiating over a single variable. The method described here improves upon that described as ICANS in U.S. Pat. No. 5,495,412 and the improvement described in U.S. patent application Ser. No. 10/022,797. Where the presently disclosed system is very similar to existing systems, these similarities are summarized here rather than repeated in detail.

As in said previously described system, the presently disclosed system assists any number of parties involved in simple or complex negotiations with any number of variables in reaching an agreement that optimizes both individual and joint gains for the parties. Parties using the system can have their own separate computer systems networked by a neutral site that manages data in such a way that each party's preference information remains confidential to that party.

The system first elicits a problem description and preferences from each negotiating party. The problem and preferences are modeled by the system in such a way that a satisfaction rating can be produced for any possible outcome. The parties begin by collaborating in building a “framework for agreement”. The framework for agreement is like a final agreement except for blanks representing unresolved issues. It may also include constraints that relate two or more variables. From the framework for agreement, a list of decision variables can be derived and entered into a computer system. Each of the parties in a conflict or dispute to be negotiated then enters their own preferences concerning each decision variable of the conflict into the computer system. They may also enter private variables and/or private constraints if this provides a better problem description.

Preference information includes data on satisfaction functions for each of the variables. Each satisfaction function defines a party's relative level of satisfaction as a function of a numerical value for the outcome of that variable. The preference information for each party includes more preferred and less preferred outcomes that define bargaining ranges and a relative importance assigned to each variable with respect to its bargaining range. Bargaining ranges define a region in which a party's satisfaction is defined for feasible packages (sets of values for each variable representing potential agreements) created within those bounds. Every package that is created by any party or by the system is associated with a specified level of satisfaction or rating for each party that is determined by the satisfaction function for that variable and relative importance of that variable. Each party has a private view in which packages are rated according to their own preferences. Parties may create any number of packages for their own private consideration or proposals and/or other packages for discussion purposes. Once the system has received the negotiation problem model and preferences from the negotiating parties, it can also generate various types of packages.

Parties may declare their acceptance of any package. Such acceptance may be kept confidential until other parties have also accepted that package. If two or more parties accept the same package, that package becomes a tentative agreement among those parties.

Proposals are defined as packages with published acceptance. Parties may choose to submit proposals in sequence or simultaneously. As an alternative to proposing a package of actual values for each negotiation variable, parties can be given the option of simply proposing a rating to the other negotiating parties. This type of proposal will be referred to here as a visible Reflection in a process defined below. FIG. 1 defines various terms used below in the description of a negotiation process with visible Reflections in the context of a hypothetical two-party negotiation scenario between Party A and Party B.

In order to keep preferences confidential, it is assumed that our negotiating parties would not want packages on the Efficiency Frontier to be revealed until they have decided how gains are going to be divided. Visible Reflections can give negotiators the best of both worlds in this situation, i.e. pointing them to an optimal solution without revealing preferences by showing parties the actual values that would make up that solution.

For the purposes of this illustration, suppose the parties propose Reflections simultaneously. Using a suitable optimization technique, looking at all packages, given the constraints of the problem (including a buffer if any), the system determines the maximum possible rating that is possible for each party while still allowing the other party to achieve a minimum specified level of satisfaction for themselves. Each of these maximum possible ratings is proposed to the opposing party.

Visible Reflections in this system are represented by actual packages. Parties may propose as many visible Reflections as they wish, each time making a concession by reducing the minimum rating that they have declared acceptable. When one party declares that a package with the rating proposed by the other party is acceptable, the system automatically generates a unique Equivalent package for both parties that would give them a level of satisfaction at least as great as those ratings that they have each declared to be acceptable.

The disclosed system also allows the parties to propose a rating in confidence (a new method of multivariate (multi-issue) blind bidding not described in U.S. patent application Ser. No. 10/022,797). In this case, the “hidden” reflected ratings are not shown to the other party until it is possible to generate a solution that simultaneously satisfies both parties. A scenario using hidden Reflections is shown in FIG. 2.

Packages that are generated by the system are done so using optimization techniques. The preferred method of optimization uses standard mixed-integer linear programming techniques to solve an appropriate optimization problem that takes into account the preference information of the parties and obeys any shared or private constraints that have been defined. If a problem cannot be represented in such a way as to allow linear optimization, non-linear methods may also be applied.

“Minimizing the maximum gain” represented by a generated package relative to accepted packages is one technique that may be used to generate an equivalent package (in terms of satisfaction levels) for two or more parties to consider. Once parties have reached a tentative agreement by any means, parties may request the system to search for an improvement in terms of satisfaction levels for all parties. A very good optimization algorithm for doing this is called “Maximizing the minimum gain”. Both of these algorithms are described elsewhere.

For maximum security of all party's confidential information, a separate computer system located at a neutral site can be connected to each individual party's computer system. In this case, packages are generated at the neutral site and transmitted back to each party's own computer system. Encryption is used to maintain transmission security. This entire system may be automated in repetitive negotiations in which the computer systems controlled by the parties may derive required input information from simulation models rather than that information having to be explicitly entered each time.

The main advantage of the disclosed system over previous systems is that it enables decision makers to quickly reach an agreement that is both fair and optimal by apparently negotiating with a single number that represents their satisfaction level for outcomes composed of values for any number and type of variables.

### BRIEF DESCRIPTION OF THE DRAWINGS

There are two figures appearing as drawings that are used in this application for the purposes of illustrating a process that we have named Reflections. These figures are referred to in the “Brief Summary of the Invention” and again in the “Detailed Description of the Invention”. These figures illustrate a hypothetical negotiation between two parties, named Party A and Party B. Each figure is a graph of the “Satisfaction of Party A” plotted against the “Satisfaction of Party B” for any possible outcome of the negotiation.

The origin on these graphs, labeled Nash Equilibrium on FIG. 1, represents the level of satisfaction that each party would achieve if no agreement were reached. These levels are also lower bounds for satisfaction levels of all feasible potential agreements. The Efficiency Frontier, which is the set of optimal potential agreements defined by the constraints of the problem, represents an upper bound of all feasible potential agreements. Also shown on FIG. 1 is a buffer, which can be set to absorb any errors in preference representation and/or as a basis for incorporating process fees.

FIG. 1 depicts a scenario where Party A and Party B have each proposed a visible Reflection represented by a level of satisfaction that they have declared acceptable (AA and BB respectively). These Reflections are represented in each party's own view by packages labeled as A1 and B1. The satisfaction that these packages would deliver to the other party can be deduced from the drawing but in the actual negotiation is unknown to either party and also irrelevant to the process.

In the graphic views of the parties receiving the generated ratings, incoming Reflections are represented by satisfaction levels of AB (Package B2) for Party B and BA (Package A2) for Party A. Satisfaction level AB is the maximum possible rating that is possible for Party B, while still allowing Party A to achieve a satisfaction rating of at least AA. Satisfaction level BA is the maximum possible rating that is possible for Party A, while still allowing Party B to achieve a satisfaction rating of at least BB. Packages A2 and B2, which are generated by the system, can appear anywhere on their own line.

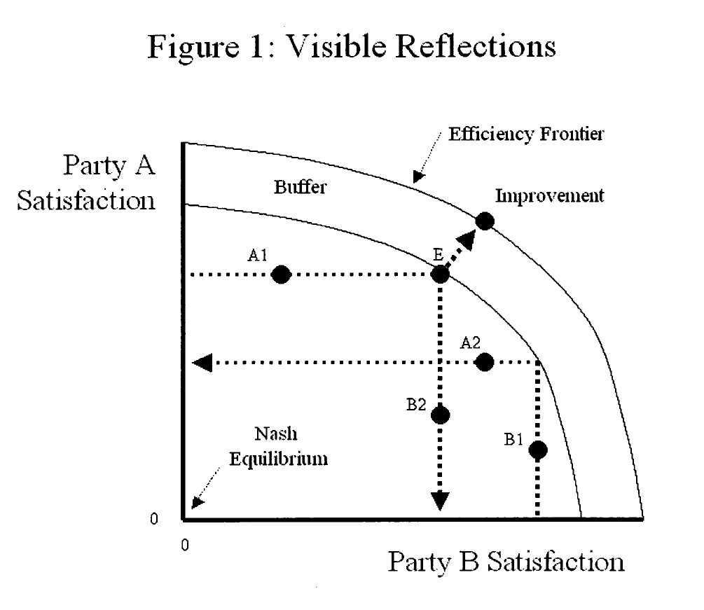

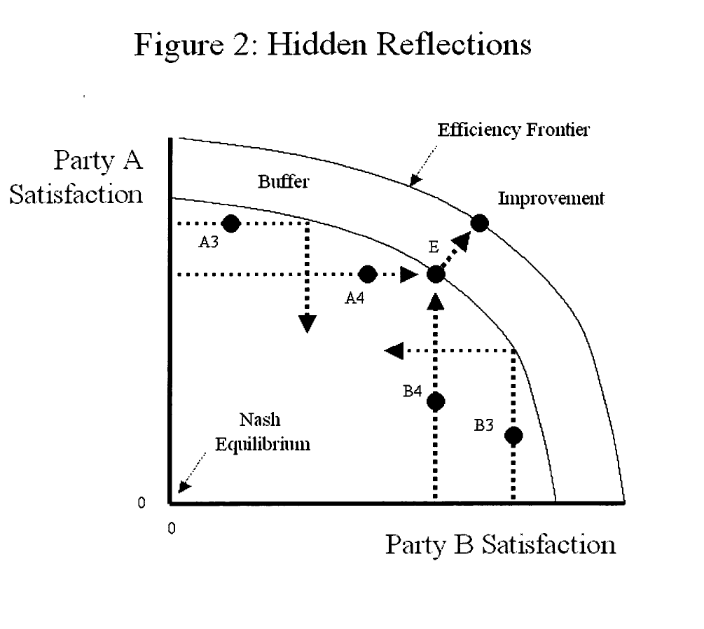

The scenario in FIG. 1 assumes that Party B accepts package B2 and the system responds by generating an Equivalent package E. After both parties accept Equivalent package E, it becomes a Tentative agreement and an Improvement is generated, represented by package I.

FIG. 2 represents a different scenario where hidden Reflections are proposed with packages that are accepted confidentially by the parties. Parties first propose hidden Reflections with packages A3 and B3 but these packages are too far apart to produce a response from the system. Packages A4 and B4, which represent concessions compared to A3 and B3, are close enough so that the system can generate an Equivalent package E. When both parties accept Equivalent package E, it becomes a Tentative agreement and an Improvement is generated, represented by package I.

### DETAILED DESCRIPTION OF THE INVENTION

### Overview

The present invention improves one aspect of a previously described system called ICANS (U.S. Pat. No. 5,495,412) and implemented by a negotiation system called SmartSettle (described in U.S. patent application Ser. No. 10/022,797) with a new method called “Multivariate Negotiation with Satisfaction Ratings” or Reflections for short. The Reflection method is described here in the wider context of the original ICANS method in order to illustrate the most preferred embodiment of the method and to assist the reader in more completely understanding the invention. The disclosed system is intended to be implemented shortly by an updated release of SmartSettle at www.smartsettle.com and will be referred to by that name throughout this description.

In general, SmartSettle is implemented on a computer by providing the negotiating parties with an acceptable interactive graphical interface. It assists any number of parties involved in simple or complex negotiations with any number of decision variables in quickly reaching an agreement that maximizes the joint gains of all parties. If desired, each party to the negotiation can have a separate computer system in a network with a neutral site so that each party's preference information remains confidential to that party.

SmartSettle requires parties to first collaborate in building a framework for agreement. The framework for agreement may include constraints that relate two or more variables. From the framework for agreement, a list of decision variables can be derived and entered into a computer system. The system then needs to elicit at least a minimum amount of preference information from each party for the purpose of representing preferred outcomes, bargaining ranges and satisfaction ratings for packages. Parties may also enter private variables and/or private constraints if this provides a better problem description. With preferences well represented, SmartSettle enables parties to generate optimal solutions to their negotiation problem and propose visible Reflections that show parties the maximum possible satisfaction of a potential agreement without actually showing them the values of decisions corresponding to that potential agreement. When parties have accepted satisfaction levels that are close enough to each other, SmartSettle reveals the optimal package that shows the actual decisions that parties would need to agree to. Parties can confirm their willingness to make those decisions by placing a confidential acceptance on the actual package. When two parties accept the same package an agreement is declared.

### Preferences Required for Package Evaluation

Before parties can enter information regarding their preferences on the outcome of a particular variable, a range of outcomes for that variable must be defined. This range is referred to here as a bargaining range. Within this range, SmartSettle, by default, generates a linear relative satisfaction function to define that party's relative level of satisfaction as a function of a numerical value for the outcome of that variable. However, the party has the option of changing that function to more accurately describe their relative satisfaction function by picking points on the graphical interface.

With bargaining ranges defined, packages (sets of potential values for each unresolved variable) can be identified. Every package that is created by any party or by the system is associated with a specified level of satisfaction or rating for each party that is determined by the satisfaction functions and relative importances for each variable included in preference analysis. Each party has a private view in which packages can be evaluated according to their own preferences.

SmartSettle provides a number of ways for each party to define the satisfaction tradeoffs between variables that determine the relative importance of each variable with respect to its bargaining range. These ways have been described earlier (see given patent references) and will not be repeated in detail here.

### Types of Packages

SmartSettle uses the ranges, satisfaction functions and satisfaction tradeoff information to generate a rating that represents the relative total satisfaction value that each package would provide to a party. Once SmartSettle has sufficient information with which to rate packages, parties can create packages that may either be private, or published for other negotiators to see. Published packages may be declared as proposals for acceptance or simply for discussion purposes.

Parties may also select from a menu, any one of several other different types of packages for SmartSettle to generate; Split, Suggestion, Equivalent, Improvement, Optimized Equivalent, or Dominant. Except for Equivalent, each of these functions always simultaneously generate an identical package for all parties, defined as follows:

Split: a package that provides each party as close as possible to, but not less than, the average of the satisfaction ratings of existing party proposals.

Suggestion: a package that falls between other existing packages (proposals and other Suggestions) in terms of satisfaction ratings to each viewing party.

Equivalent: a package that is equivalent, in terms of satisfaction ratings, to a party's least preferred acceptable package (published or private) but different enough, in terms of values for each variable, to allow a party to check their preferences. If two or more parties have made proposals or have accepted packages that are close enough to each other (in terms of satisfaction levels), the system may generate an Equivalent that simultaneously satisfies all parties by providing approximately the same level of satisfaction that they have declared acceptable. With confidential acceptances, this functionality allows the system to solve visible or invisible impasses. Whether or not SmartSettle has generated different packages for all parties, or the same identical package for all of them, is not revealed to any party unless they accept that package. In that case, it will either become an agreement or the system will demote the package to a private group.

Improvement: an optimal package that is better than the tentative agreement for at least one party and not worse for any others. An Improvement attempts to fairly divide gains among all parties relative to a Tentative agreement.

Optimized Equivalent: a package that is as good as possible for other permitting parties but still equivalent to the least preferred acceptable package of the party requesting the package. If there are more than two other permitting parties, gains are divided equally.

Dominant: an optimal package that attempts to fairly divide gains or losses among all parties relative to existing proposals. This outcome of this procedure is the same as if a Split had first been generated and then an Improvement.

### Reflections

Reflections are introduced in the presently disclosed system as a new method of negotiating. Reflections allow decision makers to negotiate in complex multivariate cases by exchanging optimal satisfaction ratings rather than actual packages. A Reflection may be visible to other parties or hidden (kept confidential).

In the case of visible Reflections, one party indirectly “proposes” a maximum rating to other parties. If a party had very high confidence that its preferences were well represented by the system and was thoroughly familiar with that representation, the system could simply display that rating. However, assuming that this is usually not the case, the system described here reveals reflected satisfaction ratings in the context of a package of actual values that would produce the specified level of satisfaction.

In order to keep preferences confidential, the system is deliberately designed not to show the optimal package associated with a reflected rating. It might do so by coincidence but no parties would know that. Usually, there would be theoretically infinitely many packages that would result in a specified level of satisfaction to any party. Rather than choose a package at random, the system looks at values in packages that parties have already created and accepted themselves and uses these values as targets. In this way, parties can influence the values that the system chooses to create a package with the specified level of satisfaction. Parties may request any number of packages to be generated with the specified rating. Examining these packages and confirming that they are rated accurately will increase their confidence that their preferences are adequately represented.

When a certain party reflects a proposal to other parties, those other parties may consider whether or not to accept it. When parties accept a reflected proposal, they are not accepting an actual package proposed by the initiator of the proposal but rather just the rating. When all parties (or a subset if coalitions are allowed) accept a reflected proposal, SmartSettle automatically generates an Equivalent package. A tentative agreement is reached when all parties accept that Equivalent package. Hidden Reflections are discussed in the context of multivariate blind bidding in the following section.

### Multivariate Blind Bidding

The previously existing method of multivariate blind bidding available to users of SmartSettle uses visible packages. In this method, SmartSettle receives published proposals or bargaining ranges and responds with visible packages that are generated as a function of user preferences as described above. Parties can see packages that are generated by SmartSettle, but are “blind” to a confidential acceptance that any party may indicate with respect to any package. When at least two parties accept the same package, an agreement is declared between those parties.

Another method of multivariate blind bidding introduced in this disclosed system uses invisible ratings. In the SmartSettle interface, this is called “reflecting a Suggestion”. Technically, this merely requires each user to accept a rating corresponding to an acceptable level of satisfaction, although, in SmartSettle, this is implemented by requiring parties to accept a package that has the acceptable rating. When parties have accepted ratings that are close enough, SmartSettle will generate an Equivalent package, i.e., a unique package that simultaneously satisfies all negotiating parties. If parties accept said Equivalent package, it becomes a Tentative agreement. Although this Tentative should already be relatively efficient within the given constraints, it can also be subsequently optimized.

### Optimization Methods

Whenever SmartSettle generates any type of package, it does so by solving an appropriate optimization problem. The preferred method is to use standard mixed-integer linear programming techniques to solve an appropriate optimization problem. If a problem cannot be represented in such a way as to allow linear optimization, non-linear methods may also be applied.

Whichever optimization method is used takes into account the preference information of the parties and obeys any shared or private constraints that have been defined. Equivalent may use an algorithm referred to as “Minimizing the Maximum Gain”, comparing existing packages to a newly generated package. Improvement uses an algorithm referred to as “Maximizing the Minimum Gain”. In this method, once parties have reached a tentative agreement by any means, parties may elect to have an optimal agreement to the conflict determined by “maximizing the minimum gain” in satisfaction achieved by each of the parties in going from the tentative to an improved package of variable values. This will, at the same time, maximize joint gains for all the parties. For further details regarding those algorithms, see the description for U.S. Pat. No. 5,495,412 (ICANS).

Multivariate blind bidding is implemented in SmartSettle with a routine called Suggestion, which can be published or reflected. In general, the objective of the published Suggestion model is to generate Suggestions that fall between other Suggestions, while filling the largest gaps, with priority on filling those gaps that fall between those packages that have already been accepted. This method tends to produce more efficient packages when parties are close together, thereby resulting in a final tentative agreement that lands relatively close to the Efficiency Frontier. The output of the reflected Suggestion model generates an Equivalent that is also relatively close to the Efficiency Frontier.

Since parties to the negotiations normally wish to have their preferences kept confidential, a neutral site networking separate computer systems for each of the parties is necessary. The separate computer systems can be programmed to carry out all of the initial calculations including generation of the relative satisfaction functions for each variable and generation of the total satisfaction for each package. This information can then be transmitted to a central computer system at a neutral site which processes all of the preference data from each of the parties, uses this information to generate requested packages, and transmits the results back to each of the parties. Encryption is used to maintain transmission security. This entire system may be automated in repetitive negotiations in which the computer systems controlled by the parties may derive required input information from simulation models rather than that information having to be explicitly entered each time.

### Illustration

The illustration that follows refers to the figures in the drawings section. It uses two scenarios of a hypothetical simple two-party negotiation between Party A and Party B. FIG. 1, which illustrates Scenario I, also defines various terms used below in this description of a negotiation process with Reflections. Although our negotiators have decided to cooperate with negotiation, they still wish to keep their preferences confidential, at least until it is determined how they are going to divide the gains from this negotiation.

Suppose that the parties here have begun their negotiation by exchanging conventional proposals and now wish to continue with Reflections. They have opted to propose these Reflections simultaneously. Party A defines a package named Al that has a satisfaction rating of AA in their private view. Party A selects said package and chooses to propose a Reflection of that package to Party B. At the same time, Party B defines a package named B1 that has a satisfaction rating of BB in their private view. Party B selects said package and chooses to propose a Reflection of that package to Party A.

Since parties have opted to reflect their proposals simultaneously, SmartSettle waits until they are both ready. Using a suitable optimization technique, given the constraints of the problem (and buffer if any), SmartSettle then determines the maximum possible rating, that is possible for each party while still allowing the other party to achieve a minimum specified level of satisfaction for themselves. Each of these maximum possible ratings is proposed to the opposing party, AB to Party B represented by package B2 and BA to Party A represented by package A2.

Since this negotiation involves many decision variables, and is therefore quite complex, neither party has a lot of confidence that their preferences are well represented by the system. It is therefore reassuring to be able to associate the proposed rating with an actual set of values for the negotiation variables. If either party is not confident about how well their preferences are represented by SmartSettle, they can request additional Equivalent packages to be generated for checking purposes. Parties can adjust their preference representation at any time during the process.

Party A examines package A2 while Party B examines package B2. While Party A is still considering A2, Party B decides that B2 with rating AB is acceptable and declares that to SmartSettle. When s/he does that, SmartSettle automatically generates a unique Equivalent package for both parties that would give them each as much satisfaction as they have indicated acceptable (labeled E on FIG. 1). With preferences well represented by this time, both parties accept Equivalent E and request an Improvement (labeled I on FIG. 1).

In Scenario II, parties choose to propose a rating in confidence, i.e., reflect Suggestions rather than Proposals. In this case, there is no such thing as acting simultaneously or taking turns since neither party knows what the other is doing. At some point, Party A reflects the package named A3. Meanwhile Party B reflects the package named B3. Sometime later, Party A reflects a package named A4. Sometime after that, when Party B reflects a package named B4, SmartSettle determines that parties are close enough to generate an Equivalent and does so automatically, resulting in package E. With preferences well represented by this time, both parties accept Equivalent E and request an Improvement (labeled I on FIG. 2).

We claim:

1. A computer-based method for assisting at least two parties involved in a negotiation problem with any number of variables in achieving a mutually satisfactory agreement on decisions to be taken on one or more of said variables comprising the steps of:
a) providing a negotiation system including at least one programmed computer system and an associated interactive graphical interface for interactive input and output of negotiation information to and from said computer system, said computer system being programmed to
display said negotiation information, including packages that each represent a potential agreement on decisions to be taken on one or more of said variables of said negotiation problem in response to entered preference data from each of said parties;
generate at least one said package;
keep confidential any private information and display that information only to the party to whom that information belongs; and
display negotiation information that is not private, including mutually acceptable packages, only to those parties with permission to see that information;
b) entering information into said negotiation system through said graphical interface, including information describing the negotiation variables, their relationship to each other, any constraints on the negotiated outcomes of those variables, and information pertaining to each said party's preferences on the outcome of each of said variable;
c) optionally entering into said negotiation system through said graphical interface, proposals and/or other packages (which may be declared private);
d) in response to said entering of said information, said negotiation system using each party's inputted information to evaluate packages by specifying a level of satisfaction according to each party's own preferences;
e) entering into said negotiation system for one or more parties, a confidential acceptable level of satisfaction and, for each of those parties, their willingness for maximum possible corresponding satisfaction levels for other parties to be generated for and revealed to other parties;
f) given said entered information, for each given said confidential acceptable level of satisfaction declared by said one or more parties, said negotiation system using optimization techniques to generate a fair distribution of maximum possible satisfaction levels for each other party;
g) revealing said maximum possible satisfaction levels to said other parties;
h) if and when each of all said other parties to the negotiation (or a subset, if coalitions are allowed) accept the said maximum satisfaction level revealed to that party, said negotiation system using optimization techniques with said entered information to generate an equivalent package that would give at least as much satisfaction to each party as they have declared acceptable;
i) revealing said equivalent package to all parties concerned;
j) using each party's inputted information to evaluate said equivalent package in terms of a specified level of satisfaction according to each party's own preferences; and
k) declaring as a tentative agreement among two or more parties, any package that has been accepted by each of those parties.

2. The computer-based method of claim 1, further including the step of using optimization techniques to generate an improved package that is Pareto optimal (if not already) according to said entered preferences (or changed preferences) and displaying said improved package on said one or more graphical interfaces.

3. The computer-based method of claim 2, wherein said step of providing a negotiation system including at least one computer system and an associated interactive graphical interface further comprises:
a) providing a plurality of independent, separate computer systems and associated interactive graphical interfaces, one each for each of said parties, each said independent, separate computer system being programmed to receive and process information from each party, including that pertaining to each of said party's preferences on the outcome of each said variable involved in said conflict; and,
b) providing a central computer system located at a neutral site and a plurality of communication links connecting each of said independent, separate computer systems to said central computer system, said central computer system being programmed to receive preference information from each of said independent, separate computer systems, generate at least one package representing a potential solution to the negotiation problem in response to entered preference information from each of said independent, separate computer systems, and securely transmit generated information and other information to be communicated between parties;
wherein, the information pertaining to each of said party's preferences remains confidential to each party.

4. The computer-based method of claim 3, further including the step of entering into said negotiation system other information from which said preference information may be derived, in an automated process not requiring a graphical interface.

5. The computer-based method of claim 1, further including the step of entering into said negotiation system other information from which said preference information may be derived, in an automated process not requiring a graphical interface.

6. A computer-based method for assisting at least two parties involved in a negotiation problem with any number of variables in achieving a mutually satisfactory agreement on decisions to be taken on one or more of said variables comprising the steps of:
a) providing a negotiation system including at least one programmed computer system and an associated interactive graphical interface for interactive input and output of negotiation information to and from said computer system, said computer system being programmed to
display said negotiation information, including packages that each represent a potential agreement on decisions to be taken on one or more of said variables of said negotiation problem in response to entered preference data from each of said parties;
generate at least one said package;
keep confidential any private information and display that information only to the party to whom that information belongs; and
display negotiation information that is not private, including mutually acceptable packages, only to those parties with permission to see that information;
b) entering information into said negotiation system through said graphical interface, including information describing the negotiation variables, their relationship to each other, any constraints on the negotiated outcomes of those variables, and information pertaining to each said party's preferences on the outcome of each of said variable;
c) optionally entering into said negotiation system through said graphical interface, proposals and/or other packages (which may be declared private);
d) in response to said entering of said information, said negotiation system using each party's inputted information to evaluate packages by specifying a level of satisfaction according to each party's own preferences;
e) entering into said negotiation system for one or more parties, a confidential acceptable level of satisfaction;
f) said negotiation system attempting to generate an equivalent package that would give at least as much satisfaction to all parties (or a subset, if coalitions are allowed) as they have declared acceptable and if not successful then requiring one or more parties to reduce their declared minimum level of satisfaction, each time attempting again to generate said equivalent package until successful;
g) when successful in said attempt, then revealing said equivalent package to all parties concerned;
h) using each party's inputted information to evaluate said equivalent package in terms of a specified level of satisfaction according to each party's own preferences; and
i) declaring as a tentative agreement among two or more parties, any package that has been accepted by each of those parties.

7. The computer-based method of claim 6, further including the step of using optimization techniques to generate an improved package that is Pareto optimal (if not already) according to said entered preferences (or changed preferences) and displaying said improved package on said one or more graphical interfaces.

8. The computer-based method of claim 7, wherein said step of providing a negotiation system including at least one computer system and an associated interactive graphical interface further comprises:
c) providing a plurality of independent, separate computer systems and associated interactive graphical interfaces, one each for each of said parties, each said independent, separate computer system being programmed to receive and process information from each party, including that pertaining to each of said party's preferences on the outcome of each said variable involved in said conflict; and
d) providing a central computer system located at a neutral site and a plurality of communication links connecting each of said independent, separate computer systems to said central computer system, said central computer system being programmed to receive preference information from each of said independent, separate computer systems, generate at least one package representing a potential solution to the negotiation problem in response to entered preference information from each of said independent, separate computer systems, and securely transmit generated information and other information to be communicated between parties;
wherein, the information pertaining to each of said party's preferences remains confidential to each party.

9. The computer-based method of claim 8, further including the step of entering into said negotiation system other information from which said preference information may be derived, in an automated process not requiring a graphical interface.

10. The computer-based method of claim 6, further including the step of entering into said negotiation system other information from which said preference information may be derived, in an automated process not requiring a graphical interface.

11. A computer-based apparatus for assisting at least two parties involved in a negotiation problem with any number of variables in achieving a mutually satisfactory agreement on decisions to be taken on one or more of said variables, comprising:
a) a plurality of independent, separate computer systems, one for each of said parties, each said computer system being programmed to receive and process communication between parties and/or other information pertaining to each said party's preferences on the outcome of each variable involved in said negotiation problem, including proposals and confidential acceptance of any package;
b) a plurality of interactive graphical interfaces connected, one for each of said independent and separate computer systems for input and output of information to and from the corresponding one of said computer systems;
c) a central computer system located at a neutral site for
processing party preference information received from each of said independent separate computer systems;
maintaining each said party's preference information confidential from every other one of said parties;
receiving a confidential acceptable level of satisfaction for an agreement from one or more parties and their willingness for maximum possible corresponding satisfaction levels for other parties to be generated for and revealed to other parties;
using optimization with given said entered information to generate a fair distribution of maximum possible satisfaction levels for each other party for each given said confidential acceptable level of satisfaction declared by said one or more parties;
revealing said maximum possible satisfaction levels to said other parties;
if and when each of all said other parties to the negotiation (or a subset if coalitions are allowed) accept the said maximum satisfaction level revealed to that party, using optimization techniques with said entered information to generate an equivalent package that would give at least as much satisfaction to all parties as they have declared acceptable;
revealing said equivalent package to all parties concerned; and
declaring as a tentative agreement among two or more parties, any package that has been accepted by each of those parties.
d) communication link means connecting each of said independent, separate computer systems with said central computer system;

12. The computer-based apparatus of claim 11, wherein said central computer system is further programmed for generating an improved package from said tentative agreement that is Pareto optimal (if not already) according to said entered preferences (or changed preferences) and displaying said improved package on said one or more graphical interfaces.

13. A computer-based apparatus for assisting at least two parties involved in a negotiation problem with any number of variables in achieving a mutually satisfactory agreement on decisions to be taken on one or more of said variables, comprising:
a) a plurality of independent, separate computer systems, one for each of said parties, each said computer system being programmed to receive and process communication between parties and/or other information pertaining to each said party's preferences on the outcome of each variable involved in said negotiation problem, including proposals and confidential acceptance of any package;
b) a plurality of interactive graphical interfaces connected, one for each of said independent and separate computer systems for input and output of information to and from the corresponding one of said computer systems;
c) a central computer system located at a neutral site for
processing party preference information received from each of said independent separate computer systems;
maintaining each said party's preference information confidential from every other one of said parties;
receiving a confidential acceptable level of satisfaction for an agreement from one or more parties; and
generating an equivalent package that would give at least as much satisfaction to all parties (or a subset if coalitions are allowed) as they have declared acceptable or, if that is not possible, then requiring one or more parties to reduce their declared minimum level of satisfaction before attempting again to generate said equivalent package, until successful;
when successful in said attempt, then revealing said equivalent package to all parties concerned; and
declaring as a tentative agreement among two or more parties, any package that has been accepted by each of those parties.
d) communication link means connecting each of said independent, separate computer systems with said central computer system;

14. The computer-based apparatus of claim 13, wherein said central computer system is further programmed for generating an improved package from said tentative agreement that is Pareto optimal (if not already) according to said entered preferences (or changed preferences).

15. A computer-based apparatus for assisting at least two parties involved in a negotiation problem with any number of variables in achieving a mutually satisfactory agreement on decisions to be taken on one or more of said variables, comprising:
a) a plurality of independent, separate computer systems, one for each of said parties, each said computer system being programmed to receive and process communication between parties and/or other information pertaining to each said party's preferences on the outcome of each variable involved in said negotiation problem, including proposals and confidential acceptance of any package;
b) a plurality of interactive graphical interfaces connected, one for each of said independent and separate computer systems for input and output of information to and from the corresponding one of said computer systems;
c) a central computer system located at a neutral site for
processing party preference information received from each of said independent separate computer systems;
maintaining each said party's preference information confidential from every other one of said parties;
receiving a confidential acceptable level of satisfaction for an agreement from one or more parties and, if they wish, their willingness for maximum possible corresponding satisfaction levels for other parties to be generated for and revealed to other parties;
using optimization with given said entered information to generate a fair distribution of maximum possible satisfaction levels for each other party for each given said confidential acceptable level of satisfaction declared by said one or more parties;
revealing said maximum possible satisfaction levels to said other parties, if so specified by the said one or more parties;
generating an equivalent package that would give at least as much satisfaction to all parties (or a subset if coalitions are allowed) as they have declared acceptable or, if that is not possible, then requiring one or more parties to reduce their declared minimum level of satisfaction before attempting again to generate said equivalent package, until successful;
if and when each of all said other parties to the negotiation (or a subset if coalitions are allowed) accept any said maximum satisfaction level revealed to that party, using optimization techniques with said entered information to generate an equivalent package that would give at least as much satisfaction to all parties as they have declared acceptable;
revealing any said equivalent package to all parties concerned; and
declaring as a tentative agreement among two or more parties, any package that has been accepted by each of those parties.
d) communication link means connecting each of said independent, separate computer systems with said central computer system;

16. The computer-based apparatus of claim 15, wherein said central computer system is further programmed for generating an improved package from said tentative agreement that is Pareto optimal (if not already) according to said entered preferences (or changed preferences).

17. A computer-based method for assisting at least two parties involved in a negotiation problem with any number of variables toward achieving an optimal, mutually satisfactory agreement on decisions to be taken on one or more of said variables comprising the steps of:
a) providing a plurality of independent, separate computer systems, one for each of said parties, each said independent, separate computer system being programmed to receive and process information pertaining to each of said party's preferences on the outcome of each said variable involved in said conflict;
b) providing a central computer system located at a neutral site and a plurality of communication links connecting each of said independent, separate computer systems to said central computer system, said central computer system being programmed to
receive preference information from each of said independent, separate computer systems;
not reveal any party's confidential information to other parties, and
generate at least one package representing a potential solution to the negotiation problem in response to entered preference information from each of said independent, separate computer systems;
c) parties cooperating in creating a shared model of the negotiation problem and entering that information into one or more of their independent, separate computer systems;
d) each party entering into their corresponding independent, separate computer systems,
any information required to define their private portion of the negotiation problem model;
any number of packages, which said packages may be private or not, and accepted or not; and/or
any other information to be communicated to other parties;
e) each party entering into their corresponding independent, separate computer systems, preference information including
a bargaining range information;
satisfaction function information;
information defining tradeoffs between variables;
an optional acceptable level of satisfaction for an agreement for which optimal ratings are to be generated for other parties;
an optional lower acceptable level of satisfaction for an agreement for which equivalent packages that would give at least that much satisfaction to each party are to be generated if possible; and/or
any other information from which such said preference information may be derived;
f) transmitting said information from each of said independent, separate computer systems to said central computer system;
g) said central computer system processing said transmitted preference information from all parties; including
generation of said optimal ratings; and
generation of said equivalent packages;
h) transmitting any said optimal ratings and said generated packages and any other said information to be communicated to other parties from the said central computer system to the appropriate said independent, separate computer systems;
i) each party responding to said transmitted information by
changing said preference information;
creating new packages;
accepting any number of packages; and/or
accepting any said optimal ratings;
j) transmitting said response from each of said independent, separate computer systems to said central computer system;
k) said central computer system declaring a tentative agreement if two or more parties have accepted the same package and transmitting that information to the appropriate said independent, separate computer systems; and
l) repeating any of the above steps any number of times.

18. The computer-based method of claim 17, further including the steps of
a) if two or more parties involved in said negotiation problem have both accepted any said package, then at the option of the parties, causing said central computer system to generate an improved package that is Pareto optimal (if not already) according to said entered preference information (or changed preference information); and
b) repeating the above step any number of times;
